(19) United States
(12) Patent Application Publication
(10) Pub. No.: US 2006/0059518 A1
(43) Pub. Date: Mar. 16, 2006

(54) Content distribution and incremental feedback control apparatus and method

(76) Inventors: Andrew J. Czuchry JR., Auburn, GA (US); William L. Florence III, Athens, GA (US)

Correspondence Address: W. EDWARD RAMAGE, COMMERCE CENTER SUITE 1000, 211 COMMERCE ST, NASHVILLE, TN, 37201, US

(21) Appl. No.: 11/269,444

(22) Filed: Nov. 8, 2005

Related U.S. Application Data
(63) Continuation-in-part of application No. 10/914,693, filed on Aug. 9, 2004.
(60) Provisional application No. 60/493,856, filed on Aug. 8, 2003.
(60) Provisional application No. 60/518,602, filed on Nov. 7, 2003.

(51) Int. Cl. H04N 5/445; H04N 7/173; G06F 13/00

(52) U.S. Cl. 725/46; 725/45; 725/114

(57) ABSTRACT

A system for authenticated content distribution and feedback control. Distribution and management of content or information from databases, or libraries of content, to a plurality of authenticated content users is controlled by a central computer processor operating a content distribution control module. Content users interface with the system through content review and organization control modules. The content distribution control module communicates with one or more content storage devices and with the content organization control modules via telecommunications links. A content interaction feedback module provides automated feedback to the content distribution control module, based upon user interaction with the content review and organization control modules and corresponding content storage devices. By integrating the automated feedback through the content interaction feedback module, along with additional release criteria, the content distribution module determines the appropriate flow of additional content to the users.

This application is a continuation-in-part of U.S. patent application Ser. No. 10/914,693, which claims priority to Provisional Application No. 60/493,856, filed Aug. 8, 2003, and Provisional Application No. 60/518,602, filed Nov. 7, 2003, by Andrew J. Czuchry, Jr., PhD, and William L. Florence, III, and is entitled in whole or in part to the filing dates thereof for priority. The specifications of U.S. patent application Ser. No. 10/914,693 and Provisional Patent Application Nos. 60/493,856 and 60/518,602 are incorporated herein in their entirety by reference.

### TECHNICAL FIELD

The present invention relates to information management and telecommunications systems. More particularly, the present invention relates to management of systems transmitting information content to authenticated users with incremental feedback control of the content distribution, and integrated content application feedback.

### BACKGROUND OF THE INVENTION

Communication is a bi-directional process, with distribution and feedback forming an integrated loop. Although many technologies exist for the distribution of high-impact visual communication (e.g., streaming video), the integrated distribution and asynchronous feedback loop system is (i) limited by bandwidth consideration, (ii) shortcut by omitting integrated feedback loops, or (iii) lacking in authenticated access control. Furthermore, as high impact visual communication and training becomes a more integral part of everyday business, education, and personal life, the volume of high-bandwidth content to be distributed to content users, and the number of users of the content continues to increase. This content includes, but is not limited to, text, graphics, video, and audio information. As the volume of content and content usage increases, the distribution and feedback of content and content interaction presents problems and challenges. The myriad of content elements needs to be organized into useful content packets or segments. The particular content segments are distributed through interactive communications networks, which have inherent bandwidth limitations, to the users. Although bandwidth capacity is generally increasing and bandwidth unit costs are decreasing, bandwidth limitations remain potentially within both the communications channel and the content server(s). Content distribution also involves appropriate controls by which the distribution of a series of content segments is accomplished in an appropriate sequential manner. Further, the distribution of content is controlled as to the particular user to receive the content (i.e., different users may receive different content packets). Additionally, after the content is received and reviewed, integrated asynchronous feedback is required to complete the communication loop.

One example of sequential distribution and feedback control of content is in the field of training and education. Educational and training curriculum typically organize content segments into meaningful teaching packages through content sequencing and packaging of content elements. These packages are provided in appropriate sequence to students or a target user group enrolled in the curriculum as specific classes, texts, work assignments, and lessons. Upon demonstration of effective mastery of the content by the target user group through testing, presentation of projects, evaluation of work product accomplished by the users, and the like, sequential distribution of subsequent content packages is effected. Note that due to channel availability limitations, users may or may not be connected to the communication channel while this interaction occurs; handling the feedback of user interaction, which may have occurred while disconnected from the communication channel, is of fundamental importance. While this model reasonably is effective in traditional educational and classroom environments, the remote access and use of content (e.g., remote education and training) between users and suppliers of content increasingly relies on telecommunications interlinkages with attendant problems discussed above.

Accordingly, there is a need in the art for managed incremental control of content distribution, feedback and organization. It is to such that the present invention is directed.

### SUMMARY OF THE INVENTION

This invention is directed to a computer-based system for content distribution and feedback control. In an exemplary embodiment, the distribution and management of content or information from databases or libraries of content to a plurality of content users is controlled by a central computer processor operating a content distribution control module. Content users interface with the system through content organization control modules. The content distribution control module communicates with one or more content storage devices and with the content organization control modules via telecommunications links, such as asynchronous communications mechanisms, satellite, wireless, Wi-Fi, cellular, peer-to-peer communications, cable, broadcast, wired, and other intranet or web network communications systems. These communications optionally may be secure or encrypted.

In one exemplary embodiment, the content distribution control module controls access by users (including restriction of access by unauthorized persons), tracks user interactions, evaluates user qualifications for content distribution, and maintains triggers by which appropriate sequential content is selected for distribution, or “pushed,” to a particular user. Distributed content may include, but is not limited to, videos, graphics, audio, documents, and web site information.

The content distribution control module may distribute the selected content to a particular user at any time, but in a preferred embodiment, the content is “pushed” to the user at selected periods of lower activity for the particular telecommunications links involved, thus increasing bandwidth efficiency in the communications network. The content distribution control module accumulates the selected content for communication during the low activity periods. Thus, in effect, the content comes to the user, rather than the user having to manually request or “go to” to the content synchronously, and asynchronous feedback is returned automatically.

In an alternate embodiment, the content distribution control takes into account other bandwidth factors such as the bandwidth available to the user, and sequences the communication of the permitted content to the user based on those factors. The sequencing of the communication involves alternate communication processes, including entire communication of the content package, parsing the content package into discrete partial packets which are subsequently re-assembled, and temporal accommodations of the communication such as time of day transfer and scheduling.

The user accesses the transferred content and undertakes the activities associated with the content, which may include reviewing the content, studying the content, and/or additional research. At appropriate periods, a feedback control module provides automated feedback of the user's work activities to the content distribution control module, based upon the user's interaction with the content organization control module and corresponding storage devices. The content distribution control module evaluates the status and release criteria for the subsequent element in the content. The content distribution control may then provide user access to and/or distribution of additional content, tests and evaluation, or results.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a schematic illustration of a content distribution and feedback control apparatus according to the present invention.

FIG. 2 is a block diagram of a user structure to access content in the distribution and feedback control apparatus illustrated in FIG. 1.

FIG. 3 is a block diagram of content communicated in the distribution and feedback control apparatus illustrated in FIG. 1.

FIG. 4 is a flow diagram illustrating content distribution and feedback control according to the present invention.

FIG. 5 illustrates a viewer used with the content distribution and feedback control apparatus illustrated in FIG. 1.

### DETAILED DESCRIPTION

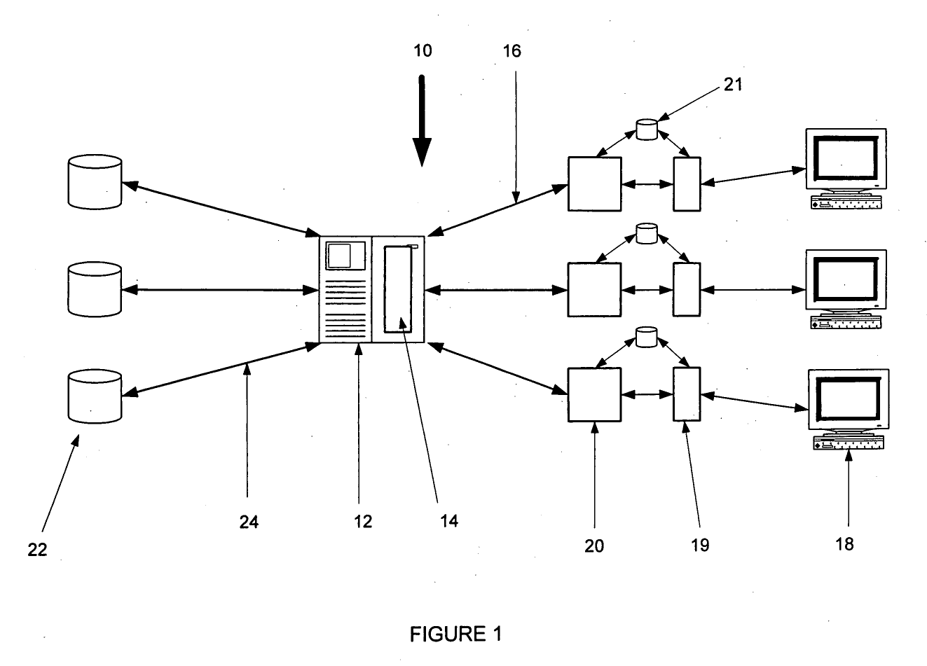

Referring now in more detail to the drawings in which like parts have like identifiers, FIG. 1 is a schematic illustration of a content distribution and feedback control apparatus 10 according to the present invention. The apparatus 10 includes a network for delivery of content while providing management within the network of an incremental distribution of “content” or information from libraries of content to users of the content based on feedback control information communicated by the users' content organization control 20. The apparatus 10 includes a computer processor 12 that operates a content distribution control 14. The content distribution control 14 communicates by telecommunications links 16 with a plurality of users 18 of the content distribution and feedback control apparatus 10. These telecommunications links include asynchronous communications mechanisms, satellite, wireless, Wi-Fi, cellular, peer-to-peer communications, cable, broadcast, wired, and other intranet or web network communications systems. Each user 18 accesses the content distribution control 14 through a content organization control 20. In an alternative embodiment, a content interaction feedback control module 19 provides automated feedback to the content distribution control 14, based upon user 18 interaction with the content organization control 20 and the corresponding content storage devices 22. Feedback can be asynchronous (i.e., the feedback processes run independently of the connection state of the content distribution control).

The content distribution control 14 also communicates with content storage 22 through links 24. The content storage 22 includes computerized databases and libraries of content or information for distribution to the users 18.

The content distribution control 14 includes appropriate and conventional security mechanisms for controlling access by users 18 to the apparatus 10 (including control and restriction of access by unauthorized persons), tracking interactions between the users 18 and the content storage 22, evaluating user qualification for content distribution, and maintaining push-oriented triggers by which appropriate sequential content is selected for distribution and subsequently communicated or “pushed” to the particular authenticated user, where it is stored on local content storage devices 21. The content distribution system of the present invention accordingly provides enhanced secure communication channels or links 16 in conjunction with the content distribution control 14 to provide secure information transfer. In one embodiment, secure communications can be achieved through the use of integrated digital signatures in one or more steps in the content distribution process. Digital signatures can be handled through a separate digital signature module, or integrated in the feedback control module 19. Additionally, content 34 communicated through the links 16, 24 may or may not be encrypted.

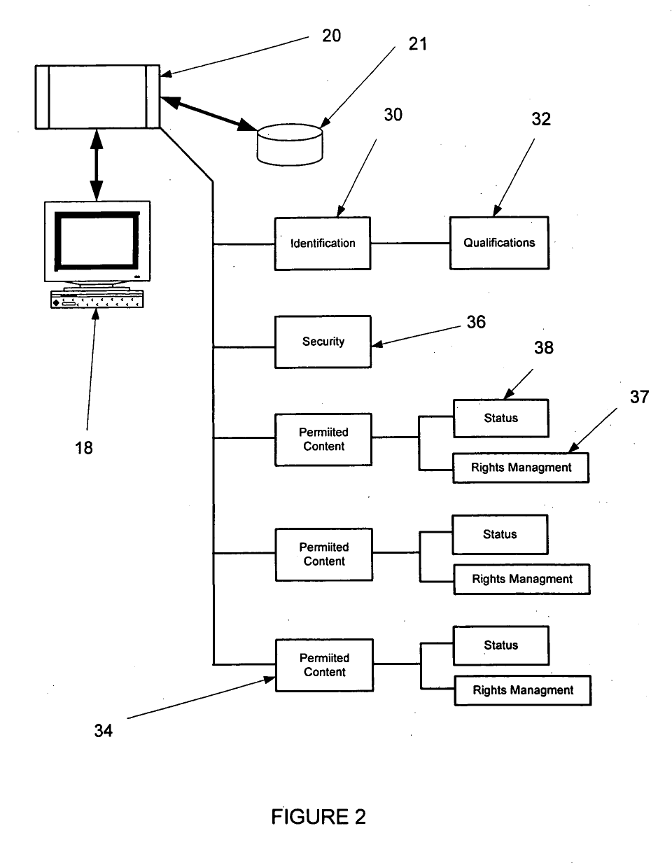

FIG. 2 is a block diagram of a structure in the content organization control 20 for a user 18 to access content in the distribution and feedback control apparatus 10 illustrated in FIG. 1. The users 18 are those entities, persons, or groups, that interact through the content delivery network with the content distribution and feedback control apparatus 10. The content organization control 20 for the particular user 18 includes identification 30 and establishing the qualifications 32 by which selected content groupings or permitted content 34 is made available to the particular user 18, content orderings, presentation of content, and controlled incremental access by the user to the content 34. Security 36 includes but is not limited to authentication (passwords and access control mechanisms) by which the user 18 accesses the content distribution control 14 through the links 16. In one exemplary embodiment, multiple layer (e.g., three layer) encryption may be used, including coding specific to the machine of the user 18. Content would be protected in accordance with applicable governmental regulations and privacy laws, such as Sarbanes-Oxley and HIPPA.

The permitted content 34 includes content status 38 by which the content distribution control 14 monitors the status of the user relative to the permitted content 34. The permitted content 34 further includes content rights management methodology or characteristics 37. The rights management characteristics define the level of protection associated with each content 34. Some content may contain technical or confidential information such that the content 34 is subject to limited distribution. The content can be provided to the user but the content cannot be further distributed by the user. Other information may be designated as “public” which allows the user to forward content to others. The rights management methodology 37 accordingly designates and controls use of the information, including proprietary, restricted, or public information.

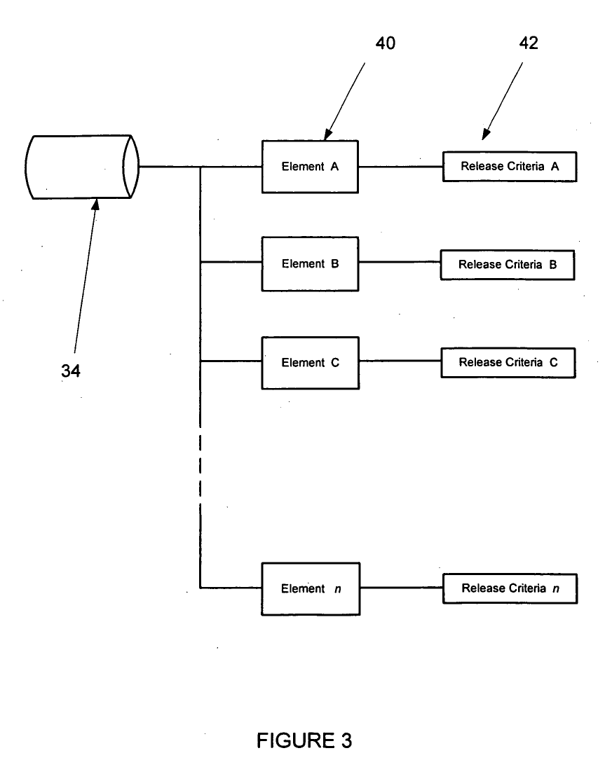

FIG. 3 is a block diagram of content available for communication in the distribution and feedback control apparatus 10. The content storage 22 includes computerized databases and libraries of content or information for distribution to the users 18. Content includes, but is not limited to, digital representations of text, audio, video, instructional, and informational bodies of expressions. Each content includes at least one but typically a plurality of content elements 40 and content release criteria 42. The content release criteria 42 define one or more requirements that must be satisfied in order for the particular content element 40 to be released by the content distribution control 14 for distribution through the communications links 24, 16 to the users 18 enabled for the content by the respective content organization control 20.

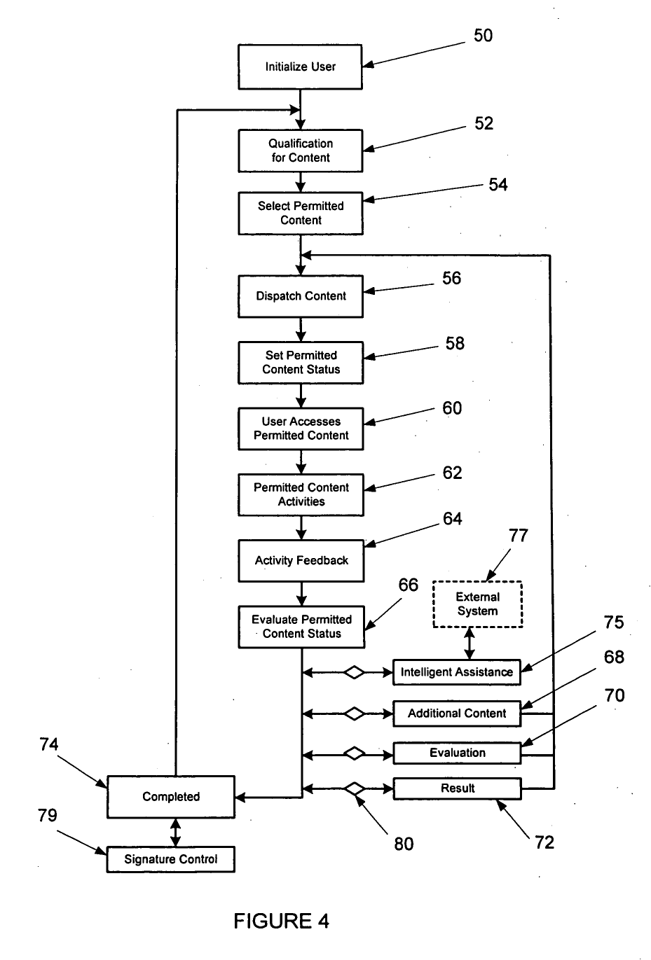

FIG. 4 is a flow diagram illustrating content distribution and feedback control according to the present invention. The content distribution control 14 interacts between the users 18 and the content storage 22. The content distribution control 14 communicates through the link 16 with the user 18 to initialize 50 the user information including establishing appropriate identification 30, entering 52 the qualifications 32 of the user, and defining the security 36 for the user. Based on the qualifications parameters, the content distribution control 14 defines 54 the permitted content 34 associated with the user 18.

The content distribution control 14 dispatches 56 the content 22 to the user. Content files dispatched to the user can be of any size. This is accomplished by the content distribution control 14 evaluating the status 38 of the permitted content 34 for the particular user 18, as maintained by the content organization control 20. The content distribution control 14 communicates the content via the links 24, 16 to the user.

The content distribution control 14 may push the content, in whole or in part, to the user at any time. It may push the content in response to a demand from the user, or at an appointment or appointed time. The user also may request that the content be released when available, so that content not accessible at the time the request is made will be sent to the user when it becomes available for release. In an alternative embodiment, distribution of the content may be accomplished according to a schedule, or in accordance with the terms of a subscription. In yet another exemplary embodiment, the content distribution control 14 pushes the content at selected periods of lower activity of the links, whereby bandwidth efficiency in the communications network is facilitated. In this embodiment, the content distribution control 14 accumulates the selected content 22 for communication at low activity periods (for example, during late evening and early morning hours local to the user 18). The permitted content communicates 56 to the user 18. The status 38 is set 58.

In another alternate embodiment, the content distribution control 14 takes into account other bandwidth factors including the bandwidth available to the user 18, and sequences the communication of the permitted content to the user. The sequencing of the communication involves alternate communications, including entire communication of the content package, parsing the content package into discrete partial packets which are subsequently re-assembled, and temporal accommodations of the communication such as time of day transfer and scheduling.

The user 18 accesses 60 the transferred content and undertakes 62 the activities associated with the content, including review, research, study, and project work. In one exemplary embodiment, at appropriate periods, a feedback control module 19 provides feedback 64 of the user's work activities. The feedback updates the status 38 of the permitted content 34. The content distribution control 14 evaluates 66 the status 38 and the release criteria 42 for the subsequent element 40 in the content. The content distribution control 14 provides additional content 68, provides tests and evaluation content 70, and results content 72. The appropriate status updates are made to the status 38. Upon completion 74, the qualifications 32 are updated 52. Subsequent content can then be provided, as discussed above.

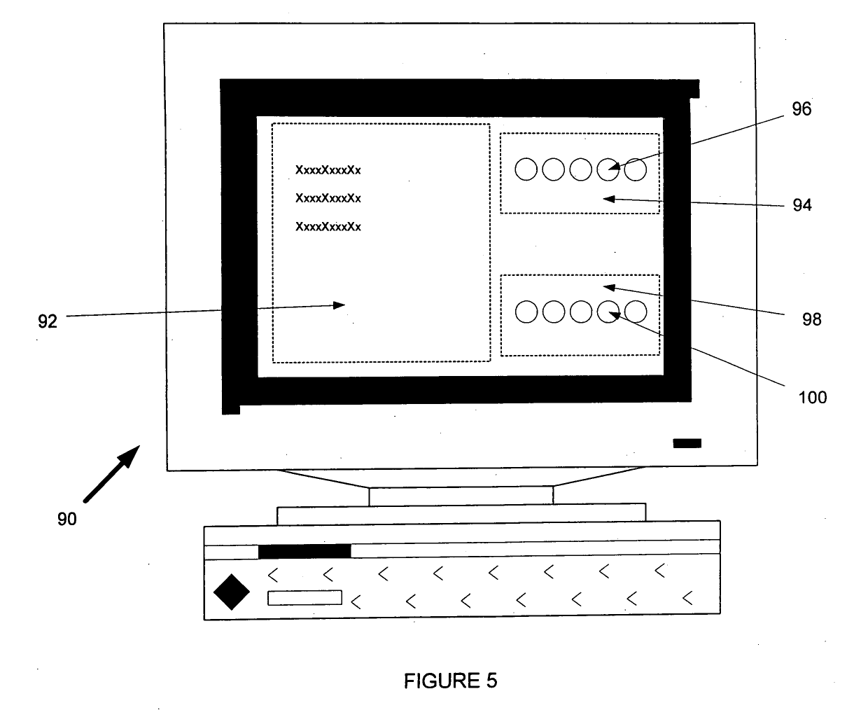

With reference to FIG. 1, the user 18 accesses content 34 through the links 16. A content organization control 20 facilitates display of content from content storage 22 on displays 20. FIG. 5 illustrates an embodiment of a viewer 90, typically a display screen of a computer monitor, for presentation of content 34. The display can vary according to the type of content viewed, and may be adjusted or customized for a particular user or type of user. The viewer 90 defines a plurality of fields, including a content display field 92, a content display control field 94 having a plurality of selectable buttons 96 and a content library access field 98 having a plurality of buttons 100 for selectably accessing content 34 from the content storage databases 22. The content 34 is displayed in the field 92. The display field 92 may be full screen, or resized to some fraction thereof (for example, placed in a “window”). The control buttons 96 in the display control field 94 are used to selectively display the retrieved content 34, as well as capture activity-based parameters such as responses to feedback inquiries (i.e., tests, quizzes, and the like) for communication through the links 16 to the content distribution control 14, as discussed above with respect to the feedback mechanism for user feedback 64 and evaluation function 70.

Content selection buttons 100 may be used to retrieve content 34 from the content storage 22. The content library viewer 90 allows for customization of sequence display buttons in order to configure the elements of a presentation for specific educational or training session. The size of the buttons 96 automatically adjust to fit on the viewer screen 90 in the field 94 to avoid the need to scroll to see the display buttons. This provides the human factors advantage that users can sequentially move between content 34 launched from each button, without having to change the mental/physical context to determine the next content button and to scroll the viewer 90 as appropriate.

Content 34 is held in local content storage 21, typically, a central repository which is also referred to as a library. One of the control buttons 100 provides access to content that is “new” to the repository, where “new” refers to content 34 added to the library or local content storage 22 subsequent to the previous access to the system by the user. Activating the selected “new” button 100 provides information from the content storage devices 22 to the user 18 as to the new content 34. In an alternate embodiment, a “pop-up messaging” display can inform the user during training sessions as to new content. In addition, content from the library can be configured into a sequence subset of buttons through a configured utility that enables the user 18 to select the sequencing of content for display.

Content 34 may be held permanently or temporarily in the local content storage 21 or otherwise on the user's hard drive or other storage media. If stored permanently, the content 34 may be available for repeated use. The content 34 may also be date-stamped and/or time-stamped, with access terminated after expiration thereof. In one exemplary embodiment, locally-stored content 34 may be retrieved and removed or deleted from local storage.

The system 10 of the present invention accordingly functions as a secure communication channel pipeline by exchanging information through links 16, 24 in a directed manner, whereby content 34 is sent to a user 18 in accordance with the status and needs of the user and the evaluation of the users feedback and status determined in response to user acting on the content and response feedback 64 sent back to the content distribution control. The content control triggers appropriate notification to the content creator or administrator. Additional content may be released either automatically, at the demand or request of the user, at an appointed or scheduled time, or at instruction of the content creator/administrator based on the status 38 of the content and the identification 30 and qualifications 32 of the user 18. For example, expert knowledge technologies such as expert systems and/or intelligence assistance can be applied within the information exchange process of the particular communication related to the content studied by the user 18 or the feedback 64 from the user.

In addition to selecting a specific one of the contents 34, the content distribution control 14 may also employ intelligence assistance 75 paradigms or example patterns showing typical elements of content 34 that can be blended or combined. The intelligent assistance 75 paradigms accordingly structure related or sequential content 34 in pre-determined training profiles and/or curriculum for user instruction, training, education, and the like. In one embodiment, the intelligent assistance 75 comprises training scripts that group selected subsets of the content 34 together with assessment feedback points. These subsets of content 34 and assessment feedback points define members or elements of a knowledge store of content segments.

The intelligent assistance 75 communicates to external systems 77, such as electronic communication of messages to an instructor with response electronic communication to the user for feedback. The feedback from the external systems 77 communicates to the user 18 within the system. This implementation accordingly provides selectively either inductive synthesis (e.g., sequential selection of content 34) internal to the content distribution control 14 or deductive analysis (e.g., structured selection), each impacting the user feedback 64, evaluation of permitted content status 66 and the provision of additional content 68 with evaluation 70 and results 72 either directly or in conjunction with the intelligent assistance 75.

The intelligent assessment 75 provides for feedback loops within decision trees evaluating permitted content activities 62, activity feedback 64 and evaluation of the status 66 and in conjunction with feed content 68, evaluation 70, and results 72. These permit a desired learning outcome synthesis mechanism that is both inductive and deductive in nature, as discussed above. Systematically, this ties into the external system 77 such as networking to a particular educator and/or trainer conducting training related to the content 34. The resulting system is an open architecture facilitating the intelligent assistance paradigm 75.

The apparatus 10 provides a secure platform for user specific content distribution, and suitably for maintaining high impact, visual communication and training content, including updates and revisions. In the system, users 18 review and study content 34 from individual discrete computers 20 remote from the content distribution control 14 with or without being directly connected through the communication link at the time of review. Content 34 can be structured for sequential access or combined into associated content packets such as the intelligent assistance 75 component discussed above. The apparatus provides for advantageous utilization of bandwidth on both the server and user portions of the communication channels 16, 24 through asynchronous distribution and feedback while communicating incremental message components that are pushed or selectively delivered to users 18 based on user metrics determined by evaluation 70 in response to user feedback 64 and completion of appropriate content 68.

Users specific reporting is handled 74 as well as verification and authentication of completions through submission control 79. Such control may include tracking the whether a file has been reviewed, the number of times a file has been reviewed, and the like. Reports about file access, file use, and the similar data, can be prepared.

In another exemplary embodiment, demographic information is collected through survey information collected from the user, such as at the time a new user downloads software components. The system also records content transfer data, so that each time a user downloads new content, such as a video or data file, that download is recorded. Demographic data can be compiled and reported. In an environment where advertiser supported material is being downloaded, use and user demographic information may be invaluable to the seller as well as the advertiser. Similarly, if a subscription model is used, credit card transactions or use transactions can be tracked and reported for either credit card billing or direct customer billing. Reports may be provided by an appropriate reporting module.

Content control is provided through rights management 37 related to each respective content 34. The users engage in activity based content distribution in which users perform content viewing activities and feedback response activities, while that activity upon completion triggers additional content distribution. For example, in the hardware/software industry, software providers e-mail patches as updates for software. Without feedback, the hardware/software vendor is uncertain as to whether the patch was implemented or not. The present content distribution and feedback apparatus provides authentication of execution of instructions or activities such as implementing patches.

Accordingly, a plurality of content elements are provided in the content distribution and feedback control apparatus, and each content element includes content (text, video, and/or audio) and release criteria. The release criteria includes one or more conditions or requirements that must be satisfied in order for the content distribution control to release the particular element for communication to the user. The content distribution control functions as a dispatcher by periodically evaluating the content elements and release criteria in view of the status of the permitted content for each user as maintained by content organization control. Further, the content distribution control functions as a feedback evaluator, receiving feedback from the user through the content organization control, determining whether the release criteria is satisfied by the user. Appropriate action is then accomplished including additional content, evaluation materials such as tests or quizzes, and results with reporting feedback to the user.

With further reference to FIG. 1, the content distribution and feedback control system of the present invention finds particular application in authenticating acquisition of the content 34 by the user. This may be validated through a signature control module 79. The entity providing the content 34 to its employee/user 18 wants verification that the particular content 34 was studied. For example, personnel/human resources training content on employment matters, legal documentation, or accessing an installation of software updates are types of applications in which the signature control 79 provides verification of content access.

The signature control 79 or digital signature 80 provides a record that the content 34 was viewed by the user 18. In one embodiment, the digital signature involves capturing identifying indicia, such as an ID address of the users computer to which the content 34 is communicated via the link 16, and as well as capturing the log-in user information and hard drive identifier. The user 18 viewing the content 34 acknowledges his receipt and review of the content 34 and thus its corresponding library component 22 by acceptance at which time the identifying indicia would be captured and return communicated as activity feedback 64.

An embodiment of the present invention provides apparatus and method for content distribution and feedback control with controlled distribution by pushing content to users over the telecommunications links while minimizing bandwidth occupancy and use during high demand periods. Content is updated by content suppliers with virtual transparency to the users. Content security is provided at the level of the incremental individual user access. A return signal provided in the content status as a feedback channel provides for sequencing of new or additional content for the user as appropriate.

The present invention may also be used as a secure messaging system or corporate training system. In one embodiment, critical messages can be highlighted or otherwise distinguished from email messages and the like. High priority and totally secure data and video messaging also can be of use for business transactions and negotiations, such as for mergers and acquisitions. As a messaging system, the present system can link top corporate management with key management personnel, or a company with its outside suppliers and/or clients.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art, and variations and changes may be made by those skilled in the art without departing from the spirit of the invention. Accordingly, it is intended that the scope of the invention be defined by the claims appended hereto.

We claim:

1. A system for content distribution, comprising:
a. a content distribution control module operated by a computer process;
b. one or more content organization control modules linked to the content distribution control module; and
c. one or more content storage devices linked to the content distribution control module.

2. The system of claim 3, wherein the content distribution control module controls and monitors interaction and access by users to the content distribution control module and content, tracks interactions between users and content storage devices, evaluates user qualifications for content distribution, and maintains triggers by which sequential content is selected for distribution and communication to a particular user.

3. The system of claim 2, wherein the content being communicated is encrypted.

4. The system of claim 3, wherein the encryption is multi-layered.

5. The system of claim 3, wherein the control organizational control module for a particular user identifies and authenticates the identity of the user, establishes the qualifications by which certain content is made available to the user, orders and presents the content to the user, and controls incremental access by the user to the content.

6. The system of claim 5, wherein content made available to the user includes the status of the content relative to the user and content rights management characteristics defining the level of protection associated with particular content.

7. The system of claim 2, wherein the content distribution control module defines content permitted to be accessed by a particular user based on the identity of the user, the qualifications of the user, and the security for the user.

8. The system of claim 7, wherein the content distribution control module evaluates the status of the permitted content for a particular user, and distributes permitted content to that user.

9. The system of claim 8, wherein selected permitted content is distributed to the user pursuant to a pre-established schedule.

10. The system of claim 8, wherein selected permitted content is distributed to the user upon receipt of a request from the user.

11. The system of claim 1, further comprising customizable means for display of content to a user.

12. The system of claim 1, further comprising one or more feedback control modules providing feedback to the content distribution control module based upon user interaction with the content organization control modules and corresponding content storage devices.

13. A method for providing content distribution and feedback, comprising:
a. receiving login information from a prospective user;
b. collecting data from the prospective user;
b. evaluating the login information to determine if the prospect user is an authorized user;
c. determining what content the user is authorized to receive;
d. distributing authorized content to the user;
e. receiving feedback confirmation that the user has received the authorized content;
f. registering and recording the user's actions in viewing the content;
g. receiving feedback confirmation that the user has viewed the content;
h. assessing whether any additional content should be distributed to the user, based on the feedback received;
i. distributing any additional authorized content to the user; and
j. receiving additional feedback results.

14. The method of claim 13, further comprising the step of reporting feedback information and results.

15. A method for providing content distribution and asynchronous feedback, comprising:
a. tracking of packets sent by a content distribution control module;
b. sending feedback to the content distribution control module regarding the packets received;
c. tracking authenticated user access to a content organization control module;
d. sending feedback to the content distribution control module regarding user access to the content organization control module;
e. tracking authenticated user access to a content viewing module;
f. sending feedback to the content distribution control module regarding user access to the content viewing module; and
g. distributing content based on feedback received from a feedback control module.
